(19) United States
(12) Patent Application Publication
(10) Pub. No.: US 2014/0121899 A1
(43) Pub. Date: May 1, 2014

(54) APPARATUS AND METHOD FOR CONTROLLING THE DISPLAY OF AN IMAGE ON A MULTI-FUNCTION MIRROR

(71) Applicant: HYUNDAI MOTOR COMPANY, Seoul (KR)

(72) Inventors: Kap Je Sung, Hwaseong (KR); Joong Ryoul Lee, Hwaseong (KR); Eu Gene Chang, Gunpo (KR)

(73) Assignee: HYUNDAI MOTOR COMPANY, Seoul (KR)

(21) Appl. No.: 13/693,951

(22) Filed: Dec. 4, 2012

(30) Foreign Application Priority Data
Oct. 31, 2012 (KR) 10-2012-0122044

(51) Int. Cl. B60R 1/02

(52) U.S. Cl. CPC B60R 1/02
USPC 701/36

(57) ABSTRACT

Disclosed herein are an apparatus and a method for controlling an image on a multi-function mirror, the apparatus for controlling an image on a multi-function mirror including: an angle sensor that measures the angle of a multi-function mirror in a vehicle; an operation sensing unit that senses the operation angle of the multi-function mirror from the value measured by the angle sensor; a view changing unit that produces a view-changed image by changing the view of an external image taken by a first camera mounted on the vehicle on the basis of the sensed operation angle of the room mirror; and an output control unit that controls the external image to be displayed on the multi-function mirror, and controls a view-changed image corresponding to the adjusted angle of the multi-function mirror to be displayed on the multi-function mirror.

### CROSS-REFERENCE TO RELATED APPLICATION

This application claims priority under 35 U.S.C. §119(a) to Korean Patent Application No. 10-2012-0122044, filed on Oct. 31, 2012, in the Korean Intellectual Property Office, the disclosure of which is incorporated herein in its entirety by reference.

### BACKGROUND OF THE INVENTION

1. Field of the Invention

The present invention relates to an apparatus and a method for controlling an image on a mirror, and more particularly, to an apparatus and a method for controlling an image from a rear view camera that is displayed on a rear-view mirror in a vehicle.

2. Description of the Prior Art

In the conventional art, a rear-view mirror in a vehicle typically allows the driver to view the back seats of the vehicle, as well as the area behind the car (e.g., other cars that are driving behind the vehicle) multi-function mirror.

Recently, mirrors such as, for example, electronic chromic mirror (ECM), Electronic Toll Collection System (ETCS), Rear Camera Display (RCD), etc., that provide multiple operating functions have been developed. For example, the RCD mirror displays an image taken by the rear view camera of a vehicle, and provides the driver with the ability to control the view of the image displayed on the RCD mirror by operating direction control buttons. Unfortunately, RCD mirrors suffer from a significant drawback because the user's ability to control the view of the image requires the use of complicated control buttons, which are difficult to manipulate while driving, and the ability to control the image is very complicated when the angle to change the view is large, and fine control of the image is difficult. Accordingly, there is a need for technology that allows a user to view and easily manipulate an image on a multi-function mirror.

### SUMMARY OF THE INVENTION

The present invention provides an apparatus and a method for controlling an image on a multi-function mirror, which displays an image on the multi-function mirror with the view changed in accordance with the angle of the multi-function mirror.

In one aspect, the present invention provides an apparatus and a method for controlling an image on a multi-function mirror which convert a display image into an internal image in response to an operation of a button while an external image is displayed on the multi-function mirror.

In another aspect, the present invention provides an apparatus for controlling an image on a multi-function mirror, including: an angle sensor that measures the angle of a multi-function mirror in a vehicle; an operation sensing unit that senses the operation angle of the multi-function mirror from the value measured by the angle sensor; a view changing unit that produces a view-changed image by changing the view of an external image taken by a first camera mounted on the vehicle on the basis of the sensed operation angle of the multi-function mirror; and an output control unit that controls the external image to be displayed on the multi-function mirror, and controls a view-changed image corresponding to the angle of the multi-function mirror to be displayed on the multi-function mirror, when the angle of the multi-function mirror is adjusted while the external image is displayed on the multi-function mirror.

The apparatus for controlling an image on a multi-function mirror may further include a mode converting unit that converts operation modes for image display operations of the multi-function mirror in accordance with operations of converting buttons.

The multi-function mirror may have several operation modes including, for example, an external image mode for displaying an external image taken by a camera mounted on the vehicle and an internal image mode for displaying an internal image taken by a camera mounted on the multi-function mirror.

The output control unit may control the internal image taken by the camera mounted on the multi-function mirror to be displayed on the multi-function mirror, when the operation mode of the multi-function mirror is converted into the internal image mode from the external image mode in accordance with an operation of the converting button.

The output control unit may control the external image displayed on the multi-function mirror to be converted into the internal image, when the operation mode of the multi-function mirror is converted into the internal image mode

The output control unit may control the external image and the internal image to be overlapped and displayed on the multi-function mirror, when the operation mode of the multi-function mirror is converted into the internal image mode.

The output control unit may control the external image and the internal image to be separately displayed on divided screens of the multi-function mirror, when the operation mode of the multi-function mirror is converted into the internal image mode.

The mode converting unit may convert the operation mode of the multi-function mirror into the external image mode, when a predetermined time has passed, after the operation mode of the mirror multi-function mirror is converted into the internal image mode.

The angle sensor may measure the angles from at least two different axes.

In another aspect of the present invention, there is provided a method for controlling an image on a multi-function mirror, including: displaying an external image taken by a cameral mounted on a vehicle, on a multi-function mirror mounted in the vehicle; when the angle of the multi-function mirror is adjusted while the external image is displayed on the multi-function mirror, sensing the operation angle of the room mirror; producing a view-changed image by changing the view of the external image in accordance with the sensed operation angle of the multi-function mirror; and displaying the view-changed image on the multi-function mirror.

The method for controlling an image on a multi-function mirror may further include converting the operation mode of the multi-function mirror from an external image mode for displaying an external image taken by the camera mounted on the vehicle into an internal image mode for displaying an internal image taken by the camera mounted on the multi-function mirror, in accordance with an operation of the converting button.

The method for controlling an image on a multi-function mirror may further include converting the external image displayed on the multi-function mirror into the internal image, when the operation mode of the multi-function mirror is converted into the internal image mode from the external image mode.

The method for controlling an image on a multi-function mirror may further include overlapping the external image and the internal image and displaying the images on the multi-function mirror, when the operation mode of the multi-function mirror is converted into the internal image mode.

The method for controlling an image on a multi-function mirror may further include separately displaying the external image and the internal image on divided screens of the multi-function mirror, when the operation mode of the multi-function mirror is converted into the internal image mode.

The method for controlling an image on a multi-function mirror may further include converting the operation mode of the multi-function mirror into the external image mode, when a predetermined time has passed, after the operation mode of the multi-function mirror is converted into the internal image mode.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a multi-function mirror according to an exemplary embodiment of the present invention;

FIG. 2 is a block diagram illustrating the configuration of an apparatus for controlling an image on a multi-function mirror according to an exemplary embodiment of the present invention;

FIG. 3 is an exemplary view illustrating the structure of an angle sensor of an apparatus for controlling an image on a multi-function mirror according to an exemplary embodiment of the present invention;

FIGS. 4 and 5 are views illustrating examples of displaying images with the view changed in accordance with direction changes of a multi-function mirror according to an exemplary embodiment of the present invention;

FIGS. 6A to 6C are views illustrating examples of converting images of the apparatus for controlling an image on a multi-function mirror according to an exemplary embodiment of the present invention; and

FIG. 7 is a flowchart illustrating the operational flow of a method for controlling an image on a multi-function mirror according to an exemplary embodiment of the present invention.

### DETAILED DESCRIPTION OF THE PREFERRED EMBODIMENTS

Hereinafter reference will now be made in detail to various embodiments of the to present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, to RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

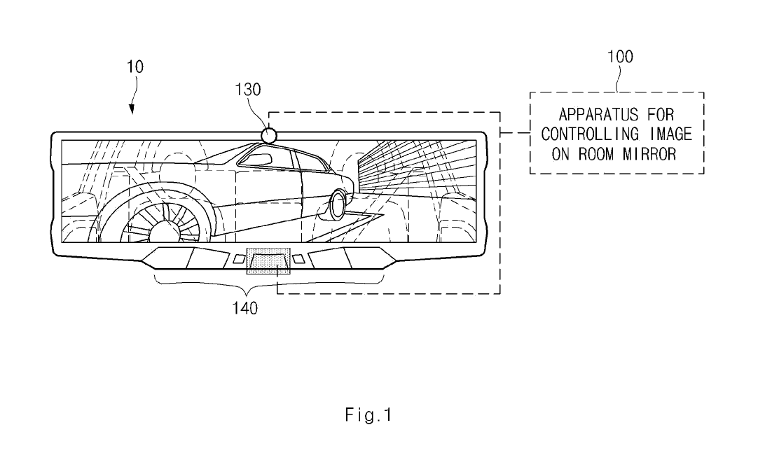

FIG. 1 is a view illustrating the configuration equipped of a multi-function mirror according to an exemplary embodiment of the present invention.

Referring to FIG. 1, a multi-function mirror 10 that is applied to the present invention may be an RCD (Rear Camera Display) mirror that displays an external image taken by a rear view camera mounted on a vehicle. An apparatus 100 for controlling an image on the multi-function mirror changes the view of an external image displayed on the multi-function mirror 10 in response to a sensed angle of the multi-function mirror 10 and displays the image with the view changed on the multi-function mirror 10.

The multi-function mirror 10 may be equipped with a camera 131 photographing the inside of the vehicle and a button input unit 140 for converting the operation modes of the multi-function mirror. The apparatus 100 for controlling an image on a multi-function mirror may be connected with the camera 131 and the button input unit 140 mounted on the multi-function mirror 10 and may allow an internal image taken by the camera 131 to be displayed on the multi-function mirror 10 in response to an operation of the conversion buttons while an external image is displayed on the multi-function mirror 10.

The conversion buttons may serve to switch between operation modes of the multi-function mirror and when the conversion buttons are operated with an external image displayed on the multi-function mirror, an internal image of a vehicle may be allowed to be displayed on the multi-function mirror. The camera 131 that photographs the interior of a vehicle may take an internal image of the vehicle in connection with the conversion buttons, when the conversion buttons are operated.

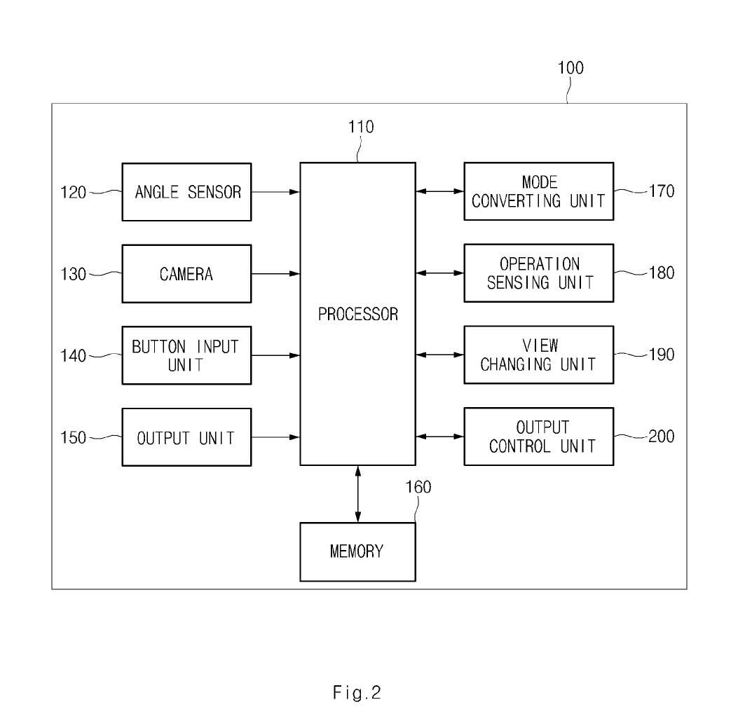

The detailed configuration of the apparatus 100 (e.g., a controller) for controlling an image on a multi-function mirror is described with reference to the exemplary embodiment illustrated in FIG. 2.

FIG. 2 is a block diagram illustrating the configuration of an apparatus for controlling an image on a multi-function mirror according to an exemplary embodiment of the present invention. An apparatus 100 (e.g., a controller) for controlling an image on a multi-function mirror includes a processor 110, memory 160, an angle sensor 120, and a camera 130. In an exemplary embodiment, the apparatus may include a plurality of units (e.g., software modules) executed by the processor, the units including: a button input unit 140, an output unit 150, a mode converting unit 170, an operation sensing unit 180, a view changing unit 190, and an output control unit 200. The processor 110 controls operations of each unit of the apparatus for controlling an image on a multi-function mirror.

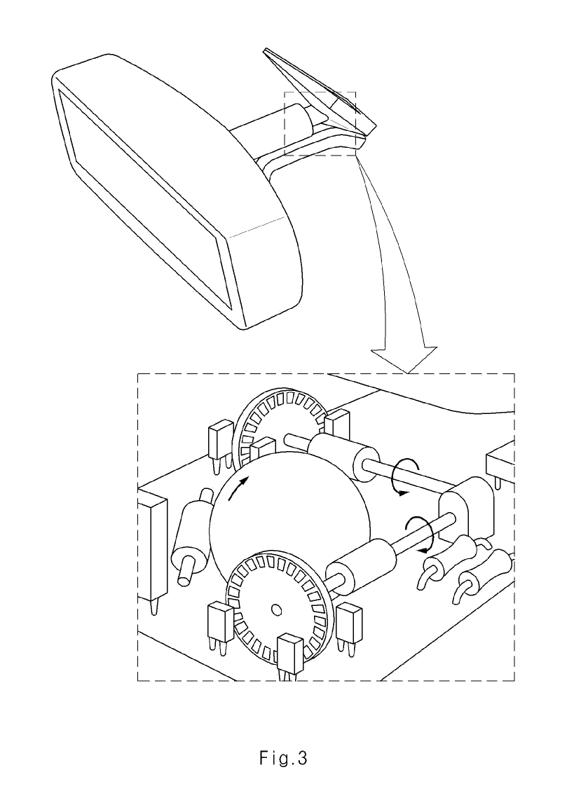

The angle sensor 120 may measure the angle of a multi-function mirror in a vehicle. The exemplary embodiment assumes that the angle sensor 120 measures the angles from at least two different axes. A detailed exemplary embodiment of the angle sensor 120 is shown in FIG. 3.

The camera 131 may include a first camera mounted on a vehicle and taking the external image of the vehicle and a second camera mounted on the multi-function mirror and taking the internal image of the vehicle. The first camera may be a rear view camera, but the present invention is not limited thereto.

The button input unit 140 may include at least one button mounted on the multi-function mirror. When at least one button of the button input unit 140 is operated, a signal corresponding to the operated button may be output to the processor 110. The button input unit 140 may include a conversion button and when the conversion button is operated, a conversion signal for converting the operation mode of the multi-function mirror is outputted to the control unit 110.

The output unit 150 may output at least one of the external images taken by the first camera and the internal image taken by the second camera to the multi-function mirror in accordance with a control instruction from the output control unit 200. Further, the output unit 150 may output the control signal from the output control unit 200 to the multi-function mirror.

Memory 160 may store default values for the operations of the apparatus for controlling an image on a multi-function mirror and may store the external image and to the internal image taken by the first camera and the second camera. Further, memory 160 may store view-changed images of the external image and the internal image.

The mode converting unit 170 may convert the operation modes for the image display operations of the multi-function mirror. The operation modes of the multi-function mirror include at least one of an external image mode displaying the external image taken by the first camera and an internal image mode displaying the internal image taken by the second camera. The mode converting unit 170, with the internal image mode as the basic mode, converts the operation mode of the multi-function mirror from the external image mode into the internal image mode, when the conversion button of the button input unit 140 is operated. Furthermore, the mode converting unit 170 may automatically convert the operation mode into the external image mode, when a predetermined time has passed with the operation mode of the multi-function mirror converted into the internal image mode.

The operation sensing unit 180 may sense the operation angle of the multi-function mirror from the value measured by the angle sensor 120.

The view changing unit 190 may produce a view-changed image by changing the view of the image taken by the first camera or the second camera on the basis of the operation angle of the multi-function mirror which may be sensed by the operation sensing unit 180. For example, when the angle of the multi-function mirror is changed while an external image taken by the first camera is displayed on the multi-function mirror, the view changing unit 190 changes the view of the external image on the basis of the sensed operation angle of the multi-function mirror. Furthermore, when the angle of the multi-function mirror is changed while an internal image taken by the second camera is displayed on the multi-function mirror, the view changing unit 190 may change the view of the internal image on the basis of the sensed operation angle of the multi-function mirror.

As described above, the view changing unit produces a view-changed image for the external image or the internal image taken by the first camera or the second camera.

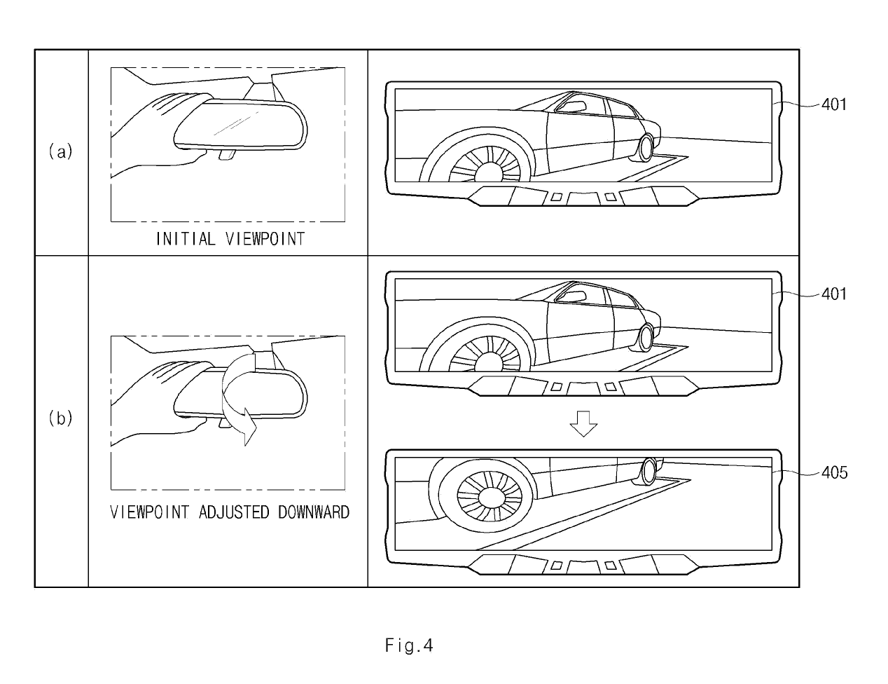

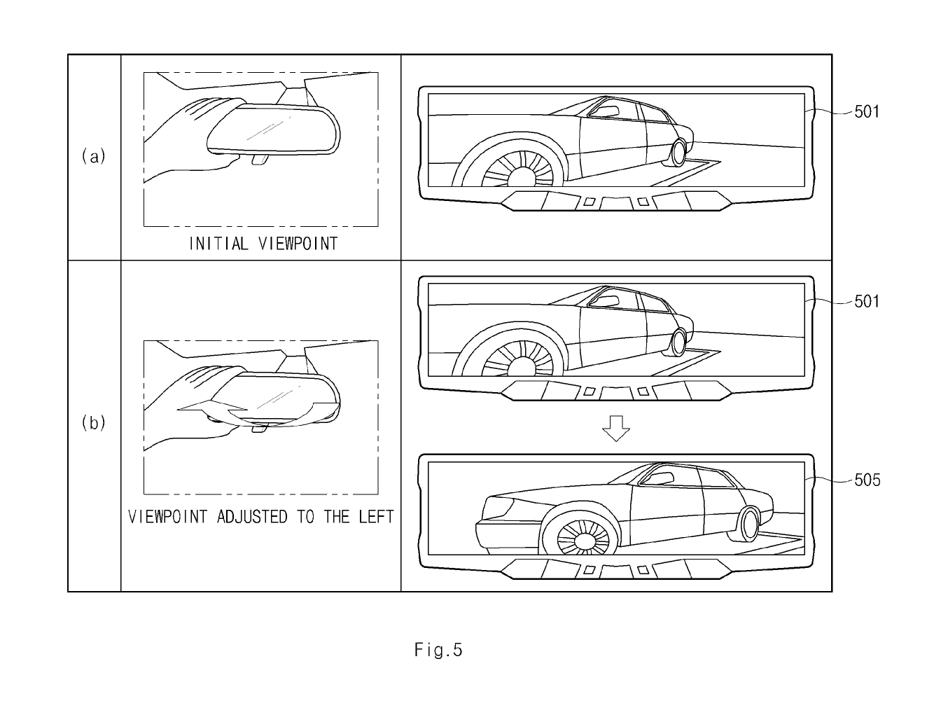

The output control unit 200 may make the external image, which is taken by the first camera, or the internal image, which is taken by the second camera, be displayed on the multi-function mirror, depending on the operation mode of the multi-function mirror. A detailed exemplary embodiment of this operation refers to the exemplary embodiments of FIGS. 4 and 5.

When the angle of the multi-function mirror is adjusted, with an internal image displayed on the multi-function mirror by the multi-function mirror operating in the external image mode, the output control unit 200 makes a view-changed image, which is produced in response to the operation angle of the multi-function mirror, be displayed on the multi-function mirror.

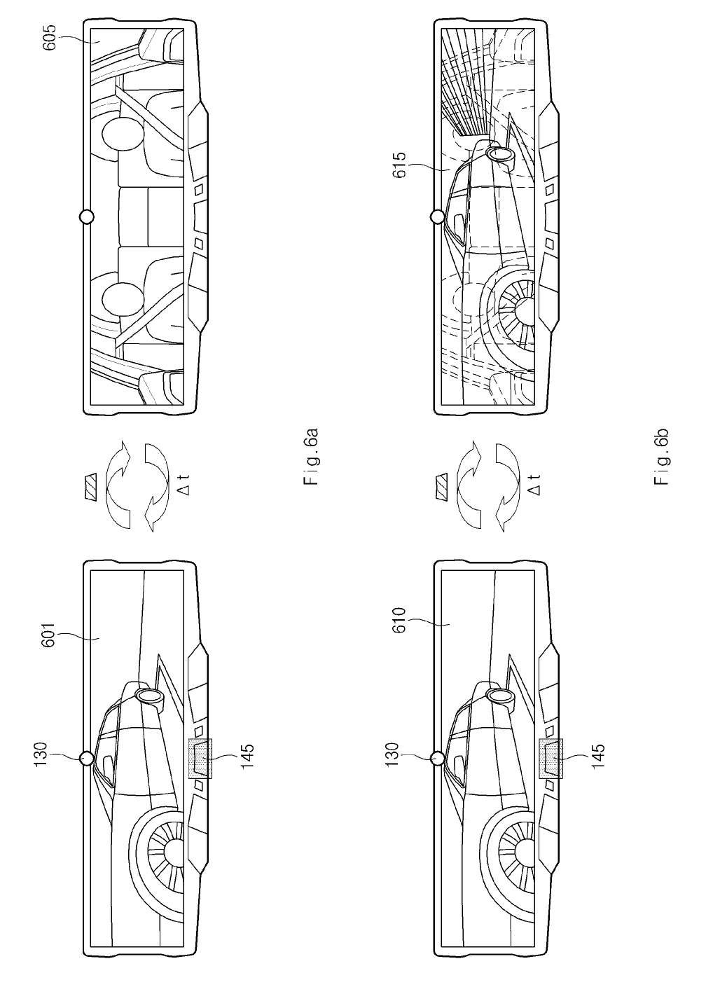

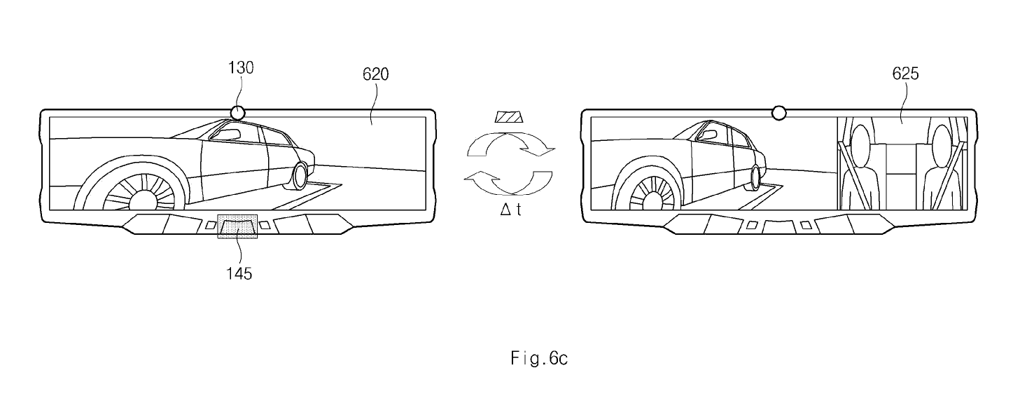

As an example, the output control unit 200 may make the image, which has been displayed on the multi-function mirror, be converted into the internal image and displayed, when the operation mode of the multi-function mirror is converted into the internal image mode. As another example, the output control unit 200 may allow the external image and the internal image to be overlapped and displayed on the multi-function mirror, when the operation mode of the multi-function mirror is converted into the internal image mode. As another example, the output control unit 200 may allow the external image and the internal image to be displayed on divided screens of the multi-function mirror, when the operation mode of the multi-function mirror is converted into the internal image mode. A detailed exemplary embodiment of this operation refers to the exemplary embodiments of FIGS. 6A to 6C.

As described above, the way of displaying the internal image on the multi-function mirror in accordance with conversion of the operation modes of the multi-function mirror is not limited to any one and can be applied in various ways.

FIG. 3 is an exemplary view illustrating the structure of an angle sensor of an apparatus for controlling an image on a multi-function mirror according to an exemplary embodiment of the present invention. Referring to FIG. 3, the angle sensor may be disposed on the mount of the multi-function mirror and senses an angle change of the multi-function mirror. The angle sensor senses the angle change according to an operation of the multi-function mirror by measuring the angle about at least two different axes.

As an example, when the angle sensor is a biaxial angle sensor that measures the angles of an x axis and a z axis, the angle sensor senses the angle change about the x axis and the angle change about the z axis, in the multi-function mirror. Obviously, the angle sensor is not limited to the exemplary embodiment.

FIGS. 4 and 5 are views illustrating examples of displaying images with the view changed in accordance with direction changes of a multi-function mirror according to an exemplary embodiment of the present invention.

Referring to FIG. 4, (a) shows when the multi-function mirror is not specifically operated from the initial viewpoint, where the apparatus for controlling an image on a multi-function mirror allows an external image 401 of the vehicle which is taken at the initially set angle to be displayed on the multi-function mirror.

On the other hand, (b) shows when the viewpoint of the multi-function mirror has been adjusted downward from the initial view point, where the apparatus for controlling an image on a multi-function mirror senses the angle of the multi-function mirror with the viewpoint adjusted downward, changes the view of the external image with a virtual camera as much as the sensed angle, and allows the external image 405 with the view changed downward to be displayed on the multi-function mirror.

Referring to FIG. 5, similar to (a) of FIG. 4, (a) shows when the multi-function mirror is not specifically operated at the initial position of the multi-function mirror, where the apparatus for controlling an image on the multi-function mirror allows an external image 501 of the vehicle which is taken at the initially set angle to be displayed on the multi-function mirror.

On the other hand, (b) shows when the viewpoint of the multi-function mirror to has been adjusted to the left from the initial view point, where the apparatus for controlling an image on a multi-function mirror senses the angle of the multi-function mirror with the viewpoint adjusted to the left, changes the view of the external image with a virtual camera as much as the sensed angle, and allows the external image 505 with the view changed to the left to be displayed on the multi-function mirror.

Although FIGS. 4 and 5 illustrate exemplary embodiments of displaying external images on the multi-function mirror, the apparatus can operate in the same way even if an internal image is displayed by operating the conversion button.

A driver easily adjust the view of an external image of the vehicle which is displayed on the multi-function mirror by adjusting the angle of the multi-function mirror, as described above, even without operating all the buttons, and the user can finely control the multi-function mirror at desired angles, because the view-changed image is displayed on the multi-function mirror in real time in accordance with the adjusted angles of the multi-function mirror.

FIGS. 6A to 6C are views illustrating examples of converting images of the apparatus for controlling an image on a multi-function mirror according to an exemplary embodiment of the present invention. FIGS. 6A to 6C show various type of displaying an internal image, as exemplary embodiments of displaying an internal image by converting the operation mode of the multi-function mirror into the internal image mode, with the multi-function mirror operating in the external image mode and displaying an external image, by operating the conversion button.

First, referring to FIG. 6A, in the apparatus for controlling an image on a multi-function mirror, when the conversion button 145 is operated while an external image 601 is displayed on the multi-function mirror, the camera 130 on the multi-function mirror takes the internal image and the internal image 605 is displayed on the multi-function mirror. The apparatus for controlling an image on a multi-function mirror may make only the internal image 605 be displayed on the multi-function mirror by converting the external image 601 that has been displayed on the multi-function mirror into the internal image 605. The apparatus for controlling an image on a multi-function mirror allows the external image to be displayed on the multi-function mirror by automatically converting the operation mode into the external image mode, when a predetermined time has passed after the operation mode is converted into the internal image mode.

Referring to FIG. 6B, in the apparatus for controlling an image on a multi-function mirror, when the conversion button 145 is operated while an external image 601 is displayed on the multi-function mirror, the camera 130 on the multi-function mirror takes the internal image and the internal image 605 may be displayed on the multi-function mirror. The apparatus for controlling an image on a multi-function mirror can allow an image 615, where the external image and the internal image taken by the camera 130 on the multi-function mirror overlap each other, to be displayed on the multi-function mirror. The apparatus for controlling an image on a multi-function mirror allows the external image to be displayed on the multi-function mirror by automatically converting the operation mode into the external image mode, when a predetermined time has passed after the operation mode is converted into the internal image mode.

Referring to FIG. 6C, in the apparatus for controlling an image on a multi-function mirror, when the conversion button 145 is operated while an external image 601 is displayed on the multi-function mirror, the camera 130 on the multi-function mirror takes the internal image and the internal image 605 is displayed on the multi-function mirror. The apparatus for controlling an image on a multi-function mirror may allow an image 625, where the external image and the internal image taken by the camera 130 on the multi-function mirror are combined, to be displayed on the multi-function mirror. In the exemplary embodiment of FIG. 6C, it is possible to display an image with two images combined and to separately display two image on divided screens by dividing the screen of the multi-function mirror. The apparatus for controlling an image on a multi-function mirror allows the external image to be displayed on the multi-function mirror by automatically converting the operation mode into the external image mode, when a predetermined time has passed after the operation mode is converted into the internal image mode.

The operational flow in the apparatus for controlling an image on a multi-function mirror having the configuration described above, according to an embodiment of the present invention, is described hereafter in more detail.

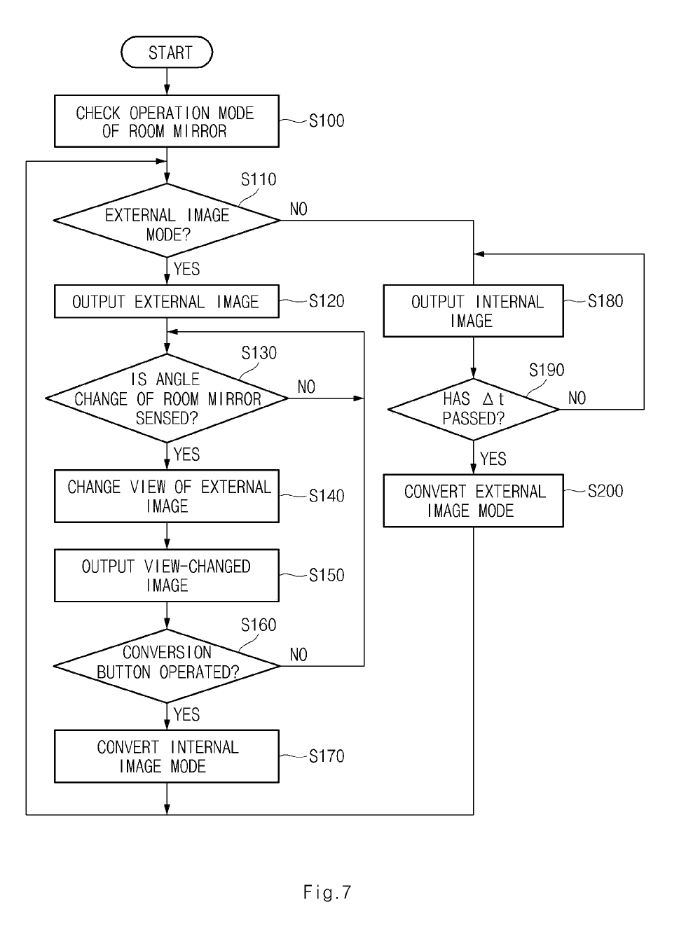

FIG. 7 is a flowchart illustrating the operational flow of a method for controlling an image on a multi-function mirror according to an exemplary embodiment of the to present invention. Referring to FIG. 7, the apparatus for controlling an image on a multi-function mirror checks the operation mode of a multi-function mirror (S100), and outputs an external image on the multi-function mirror (S120), when the operation mode is an external image mode (S110). It is assumed in that the external image mode in the operation modes of the multi-function mirror is set as the basic operation mode.

When an angle change of the multi-function mirror is sensed while an external image is output on the multi-function mirror (S130), the apparatus for controlling an image on a multi-function mirror changes the view of the external image in accordance with the angle change sensed in the process of ‘S130’ (S140), and allows the image with the view changed in the process of ‘S140’ to be displayed on the multi-function mirror (S150). The processes from ‘S130’ to ‘S150’ are repeated until the conversion button for converting the operation modes of the multi-function mirror is operated.

Further, when the conversion button is operated while an external image is displayed on the multi-function mirror (S160), the apparatus for controlling an image on a multi-function mirror converts the operation mode of the multi-function mirror into an internal image mode (S170). Thereafter, as the multi-function mirror operates in the internal image mode, the apparatus for controlling an image on a multi-function mirror allows the internal image to be displayed on the multi-function mirror (S180). The internal image is taken by a camera that is turned on to take an internal image when the conversion button is operated.

The apparatus for controlling an image on a multi-function mirror keeps the internal image displayed on the multi-function mirror before a predetermined time Δt passes after the operation mode of the multi-function mirror is converted into the internal image mode, and it automatically converts the operation mode of the multi-function mirror into the external image mode (S200), when the predetermined time has passed (S190). Therefore, the apparatus for controlling an image on a multi-function mirror returns to the process of ‘S110’ such that the external image is outputted on the multi-function mirror before a specific conversion button is operated.

According to the present invention, it is possible to easily adjust the view of an image displayed on a multi-function mirror, by displaying an image with the view changed in accordance with an angle change of a multi-function mirror, on the multi-function mirror.

Further, it is possible to easily convert images by converting the image displayed on the multi-function mirror from an external image into an internal image, by operating a button, in order to implement the original function of the multi-function mirror.

As described above, although an apparatus and a method for controlling an image on a multi-function mirror according to the present invention were described with reference to the accompanying drawings, the present invention is not limited to the exemplary embodiments described herein and the accompanying drawings and may be modified within the protection range of the scope of the present invention.

What is claimed is:

1. An apparatus for controlling an image on a multi-function mirror, comprising:
a processor;
memory;
an angle sensor that measures an angle of a multi-function mirror in a vehicle;
an operation sensing unit that senses an operation angle of the multi-function mirror from a value measured by the angle sensor;
a view changing unit that produces a view-changed image by changing a first view of the image taken by a first camera mounted on the vehicle based on the sensed operation angle; and
an output control unit that controls the first image taken by the camera to be displayed on the multi-function mirror, and controls a view-changed image corresponding to the adjusted angle of the multi-function mirror to be displayed on the multi-function mirror, when the angle of the multi-function mirror is adjusted while the image is displayed on the multi-function mirror.

2. The apparatus according to claim 1, further comprising a mode converting unit that converts between one or more operation modes the multi-function mirror.

3. The apparatus according to claim 2, wherein the one or more operation modes are selected from the group consisting of an external image mode for displaying an external image of the vehicle and an internal image mode for displaying an internal image of the vehicle.

4. The apparatus according to claim 3, wherein the output control unit controls the internal image to be displayed on the multi-function mirror, when the operation mode of the multi-function mirror is converted into the internal image mode from the external image mode in accordance with an operation of the converting button while the external image is displayed on the multi-function mirror.

5. The apparatus according to claim 4, wherein the output control unit controls the image displayed on the multi-function mirror to be converted into the internal image, when the operation mode of the multi-function mirror is converted into the internal image mode.

6. The apparatus according to claim 4, wherein the output control unit controls the external image and the internal image to be overlapped and displayed on the multi-function mirror, when the operation mode of the multi-function mirror is converted into the internal image mode.

7. The apparatus according to claim 4, wherein the output control unit controls the external image and the internal image to be separately displayed on divided screens of the multi-function mirror, when the operation mode of the multi-function mirror is converted into the internal image mode.

8. The apparatus according to claim 3, wherein the mode converting unit converts the operation mode of the multi-function mirror into the external image mode, when a predetermined time has passed, after the operation mode of the multi-function mirror is converted into the internal image mode.

9. The apparatus according to claim 1, wherein the angle sensor measures one or more angles from one or more different axes.

10. A method for controlling an image on a multi-function mirror, the method comprising:
receiving an image from a camera disposed on a vehicle;
displaying the image on a multi-function mirror;
sensing an adjusted angle of the multi-function mirror when the multi-function mirror is adjusted while the image is displayed;
producing a view-changed image by changing the view of the image to correspond to the sensed adjusted angle of the multi-function mirror; and
displaying the view-changed image on the multi-function mirror.

11. The method according to claim 10, further comprising converting the operation mode of the room mirror from an external image mode into an internal image mode for displaying the internal image of the vehicle, when a converting button is operated while the external image mode for displaying an external image of the vehicle is operated.

12. The method according to claim 11, further comprising converting the image displayed on the multi-function mirror into the internal image, when the operation mode of the multi-function mirror is converted into the internal image mode from the external image mode.

13. The method according to claim 11, further comprising overlapping the external image and the internal image and displaying the images on the multi-function mirror, when the operation mode of the multi-function mirror is converted into the internal image mode.

14. The method according to claim 11, further comprising separately displaying the external image and the internal image on divided screens of the multi-function mirror, when the operation mode of the multi-function mirror is converted into the internal image mode.

15. The method according to claim 11, further comprising converting the operation mode of the multi-function mirror into the external image mode, when a predetermined time has passed, after the operation mode of the multi-function mirror is converted into the internal image mode.

16. A non-transitory computer readable medium containing program instructions executed by a processor or controller, the computer readable medium comprising:
program instructions that receive an image from a camera disposed on a vehicle;
program instructions that display the image on a multi-function mirror;
program instructions that sense an adjusted angle of the multi-function mirror when the multi-function mirror is adjusted while the image is displayed;
program instructions that produce a view-changed image by changing the view of the image to correspond to the sensed adjusted angle of the multi-function mirror; and
program instructions that display the view-changed image on the multi-function mirror.
